(19) United States
(12) Patent Application Publication
(10) Pub. No.: US 2015/0073825 A1
(43) Pub. Date: Mar. 12, 2015

(54) METHOD FOR ONLINE MEDICAL CONSULTATIONS, AND APPARATUS AND SYSTEM UTILIZING SAME

(71) Applicant: DermLink, Inc., a Delaware Corporation, Menlo Park, CA (US)

(72) Inventor: Victor Gane, Atherton, CA (US)

(21) Appl. No.: 14/485,658

(22) Filed: Sep. 12, 2014

Related U.S. Application Data
(60) Provisional application No. 61/877,249, filed on Sep. 12, 2013.

(51) Int. Cl. G06F 19/00

(52) U.S. Cl. CPC G06F 19/327; G06F 19/322; G06F 19/363; G06F 19/321
USPC 705/2

(57) ABSTRACT

A method for a patient having a computing device to communicate with clinical medical personnel regarding a surgical procedure. The method can include opening an internet-accessible application, accessing a page of the application, inputting information pertaining to the surgical procedure into a plurality of input fields, and receiving a communication on the computing device from the clinical medical personnel in response to the inputted information.

### CROSS REFERENCE TO RELATED APPLICATION

The application claims priority to U.S. provisional application Ser. No. 61/877,249 filed Sep. 12, 2013, the entire content of which is incorporated herein by this reference.

### FIELD OF THE INVENTION

The present invention relates generally to medical communications and more specifically to online medical communications.

### BACKGROUND OF THE INVENTION

In current medical practice, patients requiring a new cosmetic or plastic surgery procedure or a follow up to an already performed procedure typically need to visit the physician's office to have a face-to-face interaction with the physician. Pre-procedure visits are required to assess a patient's preferences for the desired procedure, learn their background information and medical history, discuss options and anticipated costs, collect signed consent forms releasing the physician of liability. Post-procedure follow-up visits are required to ensure the healing process is proceeding as anticipated and without complications. However, certain categories of patients cannot easily visit a physician's office for their post procedure care for reasons that can include lack of geographic proximity, health issues, or busy professional schedules. Post procedure complications, for example, can result in corrective procedures being required, which adds to a patient's cost but also exposes the physician to significant liability risk. There is a need for an improved medical communication system that facilitates and makes more efficient communications between medical personnel and patients.

### BRIEF DESCRIPTION OF THE DRAWINGS

The drawings described herein are for illustration purposes only and are not intended to limit the scope of the present disclosure in any way.

FIG. 1 illustrates a system environment of one embodiment of the present invention that enables connecting patients, physicians, and staff members online using internet-enabled devices, a cloud or media server and the Internet.

FIG. 2 illustrates one embodiment of the architecture of the system of FIG. 1.

FIG. 3 illustrates a portion of one embodiment of the architecture of the physician component and modules of the system of FIG. 1.

FIG. 4 illustrates another portion of one embodiment of the architecture of the physician component and modules of the system of FIG. 1.

FIG. 5 illustrates one embodiment of the architecture of the staff member component and modules of the system of FIG. 1.

FIG. 6 illustrates one embodiment of the architecture of the patient component and modules of the system of FIG. 1.

### DETAILED DESCRIPTION OF THE INVENTION

The system architecture along with the architecture of the components and modules comprising the invention will be described next with references to the accompanying drawings. The invention facilitates online communications and consultations between patients and medical personnel, including physicians, surgeons, nurses and physician assistants. In one embodiment, such online communications are secure communications. In one embodiment, the invention relates generally to information organization, process modeling and methods for enabling secure online engagement of patients by aesthetic and cosmetic physicians.

In one embodiment, the invention enables patients with any internet-enabled device, for example computers, tablets or mobile phones, to connect with a physician of their choice for new procedure consultations or for post-procedure follow-up consultations with their existing physician. The invention can optimize the workflow of aesthetic practices that include physicians and staff members and can dramatically increase their efficiency while decreasing liability risk.

In one embodiment, a system and method for private and secure online engagement of aesthetic and cosmetic patients by surgeons, dermatologists, and med spas is provided. The system and method can enable physicians to consult online prospective and existing patients for their pre-procedure and post-procedure consultation needs. The system and method can enable physicians to provide comprehensive in scope online assessments mimicking in-office patient visits through images, videos and questions and answers captured on any network-enabled device, for example a computer, mobile phone, or tablet. Physicians can consult online patients interested in having new aesthetic procedures performed before a procedure is scheduled. Such consultations can result in patients receiving procedure cost estimations, pre-procedure instructions and a scheduled procedure date and time. Physicians can consult online patients that had a procedure and require a post-procedure assessment by their physician. It appreciated the system of the invention can be utilized in other medical areas beyond aesthetics, cosmetics and dermatology.

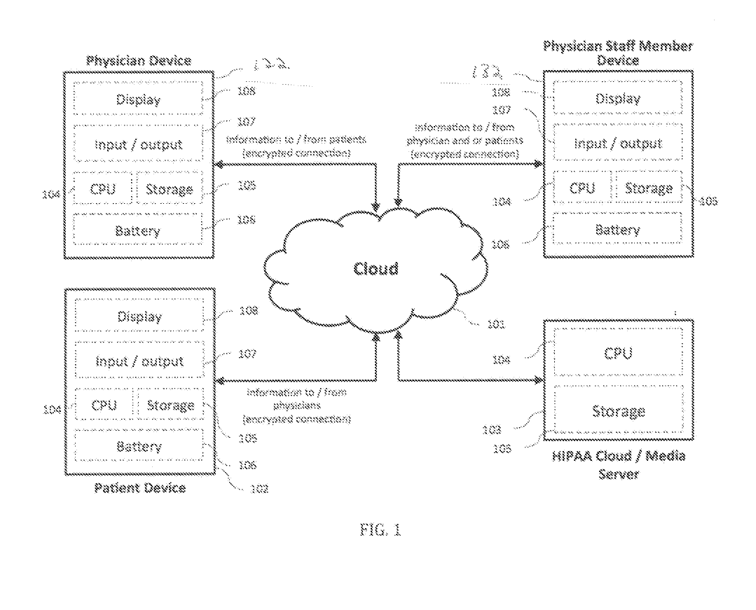

In one embodiment, the invention is a software-enabled process that provides patients with the ability to use any web browser on their computer, mobile device or other computing device 102 to submit information via the Internet 101 to a HIPAA Cloud and Media server 103, or other cloud-based system, that securely channels the patient information to a physician or other medical personnel's computer, computing device or mobile device 122. An exemplary system utilizing the invention is illustrated in FIG. 1.

The cloud server 103 can be a single server, as shown in FIG. 1, or a plurality of servers. Each cloud server 103 can include storage or memory 105 of any suitable type and a processor such as a central processing unit 104 coupled to the storage. The patient and physician devices 102,122 can each be a mobile smart device such as a tablet or smart phone having storage or memory 105 of any suitable device, a processor such as a central processing unit 104 coupled to the storage, a battery 106 and a display 108. Each such smart device can additionally include an input/output device, which in one embodiment is part of the display 108.

The invention can be embodied in software, which can be stored on any suitable computer readable medium, for example non-transitory computer readable storage media, including one or more of any of the storage components of the system utilizing the invention. In one embodiment, the software of the invention is stored on the storage or memory of the cloud server 103. The software stored on the memory of the server can include a database. The invention can additionally include software such as a mobile application that can be downloaded from the cloud server 103 on to the patient device 102 and a mobile application that can be downloaded from the cloud server 103 on to the physician device 122. The mobile application for the patient device can be the same as or different from the mobile application for the physician device. Each mobile application can permit the user of the respective device to interact with the software stored on the cloud server 103.

The system utilizing the invention can additionally include a computing device, such as computing device 132 of the physician staff member in FIG. 1, for use by medical staff related to the physician. The computing device 132 of the medical staff can be of any suitable type such as a personal computer, a mobile device, a tablet or a smart phone, and in one embodiment can include the various internal components discussed above with respect to patient computing device 102. The invention can additionally include software such as a mobile or other application that can be downloaded from the cloud server 103 or otherwise loaded on to the computing device 132 of the medical staff member, and can permit the medical staff to interact with the software stored on the cloud server. Systems can be provided having both a patient computing device 102 and a physician computing device 122, or only one of the foregoing. Accordingly, in one embodiment, some or all of software component #1, for example software component 201 disclosed herein, can be combined with some or all of software component #2, for example software component 202 disclosed herein.

In one embodiment, the software of the invention allows medical personnel, such as cosmetic dermatologists and plastic surgeons, to provide remote consultations without the need to see patients in person. In one embodiment, the remote consultations relate to a clinical procedure, for example a surgical procedure. The surgical procedure can include cosmetic or plastic surgery procedures. The consultations can be before the procedure, after the procedure or both. Such consultations can include online asynchronous or live consultations. The types of patients that can use the invention can include existing post-procedure or other patients who for example can submit online follow-up consultation requests or other communications, and prospective new patients who for example can submit new, pre-procedure or other inquiries to physicians or other medical personnel.

In one embodiment, the software of the invention facilitates remote post and pre-procedure Consultations of Cosmetic Dermatology and Plastic Surgery Patients (RCCDPSP) so as to enable dermatologists and plastic surgeons, and their personnel, to provide online remote consultations to patients. Such patients can include existing patients that have undergone a procedure and new patients that are considering a cosmetic procedure.

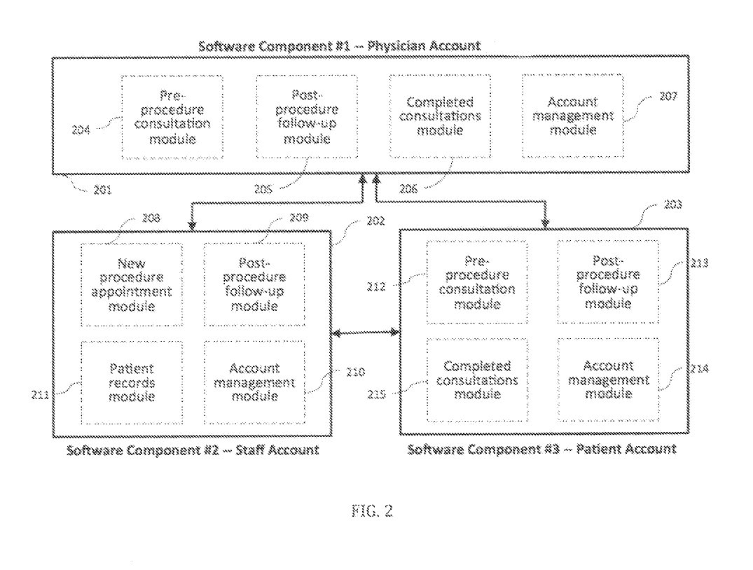

In one embodiment, the software of the invention can include interlinked software components, such as a physician account 201, a staff account 202, and a patient account 203, each with multiple software modules 204-207, 208-211, 212-214, for example as shown in FIG. 2. Any or all of the software modules can be in a predetermined format, including questions, comments, requests for information or any combination of the foregoing, created by the physician and/or the physician's medical staff. In one embodiment, any or all of the software modules are created by one or more templates of the invention, which can be combined or edited in the creation of the respective module.

Each of the software components of the invention, for example physician account software 201, staff account software 202 and patient account software 203, can serve to configure the display of the respective computing device in a suitable manner to facilitate communication by the respective user with the system. For example, a mobile application of the system can provide one or more screens on the display of a mobile device for permitting a user of the system to input or receive the information set forth herein. Similarly, the system can provide a web browser on the display of a mobile device, portable device or other computing device of the system for permitting a user of the system to input or receive the information set forth herein. Such configured displays can include preconfigured fields and boxes for inputting and receiving information.

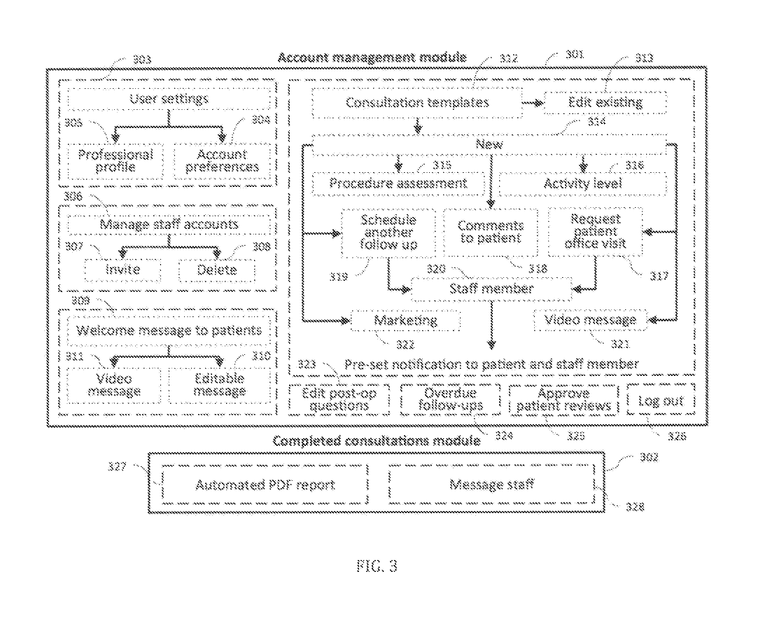

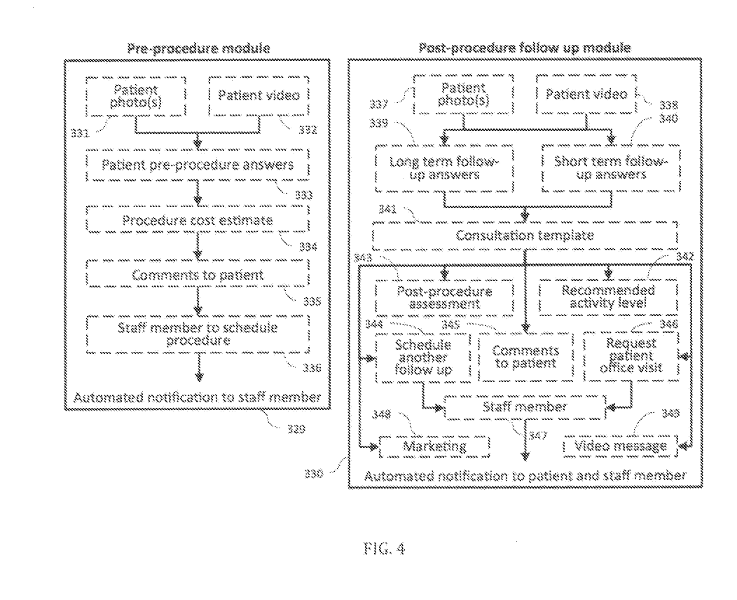

The invention can enable cosmetic dermatologists, plastic surgeons or other physicians to use secure software accessed through any web browser on a computer, mobile device or other computing device, for example computing device 122, to provide remote asynchronous pre-procedure and post-procedure consultations to patients and thus greatly improve the efficiency of their practice. The physician account software 201, or software component #1, can be of any suitable type and include any number of modules. In one embodiment, physician account software 201 includes the four software or interface modules illustrated in FIGS. 2-4.

In one embodiment, the account management module 207 can be in the form of some or all of module 301 and can enable the physician or other medical staff person to set up, maintain, and interact with their account. In User settings the physician can provides their professional profile 305 required to provide online services and decides in account preferences 304 the preferred automated contact methods, for example, phone call, text message or email, when patients submit their personal healthcare information for evaluation as a consultation request.

In Manage staff account 306, the physician can perform various administrative tasks such as inviting a staff member 307 to be linked to his/her account and deleting a staff member when needed 308.

In the Welcome message to patients 309, the physician can create and edit the welcome text-based message constraining instructions to the patients on how to use the service and records an optional welcome video and audio message to their patients. Audio/video interface 311 can be designed to record and display audio/video signals such as the sound of the human voice and the image recording of the human interlocutor.

In Consultation templates 312, the physician can create new templates 314 or edit existing reusable templates 313 for each new procedure or post-procedure evaluation type, which include the details of a complete consultation such as procedure assessment 315, recommended physical activity level 316, requesting a patient to visit the office 317, writing consultation comments to the patient 318, scheduling another online post-procedure follow-up on a specified date 319 and requesting the staff member to complete the task of scheduling the patient for an online follow-up or an in-office visit 320, attaching marketing or educational materials 322 and enabling the physician to market to their patients as part of the online consultations, and recording a video message 321. The consultation templates can include the pre-set notification to patient and staff member when the physician uses a template for an actual consultation.

In edit post-op questions 323, the physician can edit the questions to ask pre-procedure and follow up patients.

In overdue follow-ups 324, the physician can visualize patients that are overdue for a physician-requested online follow-up consultation.

In approving reviews 325, the physician can approve or reject patient reviews before they are posted to the physician profile.

In 326, the physician can logs out of the account.

In one embodiment, the completed consultations module 206 can be in the form of some or all of completed consultations module 302 and can enable the physician or other medical staff person to log in to physician account, using secure protocols, to access any previously completed consultations stored in the database on the HIPAA-compliant cloud server 103 and integrate consultation results with existing Electronic Medical Records software through automatically generated PDF reports 327 that incorporate complete records (for example patient answers, photos, physician consultation) of any patient online pre-procedure and follow-up consultation and mitigates medical liability risks by capturing the requested follow-up date for patients, the date when the patient viewed the consultation and the pre and post-procedure patient forms. The completed consultations module 302 can enable the physician to generate secure targeted messages to specific staff members 328 liked to the physician account.

In one embodiment, the pre-procedure module 204 can be in the form of some or all of pre-procedure module 329 and can enable the physician or other medical staff person to log in to the physician account, using secure protocols, to review the information submitted by their pre-procedure patients (for example stored in the database on the storage of the cloud server 105). Such information can include but is not limited to a patient's photo(s) 331 of their pre-procedure site and an optional audio/video recording 332 of the patient's message to the physician and the patient-provided answers 333 to pre-procedure questions. Based on the reviewed patient information, the physician can provide a cost estimate for the patient desired procedure 334, write comments regarding the patient desired procedure 335, and select staff member to be notified regarding scheduling a procedure date/time 336.

In one embodiment, the post-procedure module 205 can be in the form of some or all of post-procedure follow-up module 330 and can enable the physician or other medical staff person to log in to the physician account, using secure protocols, to review the information submitted by their post-procedure follow-up patients (for example stored in the database on the storage of the cloud server 105). Such information can include but is not limited to a patient's photo(s) 337 of their post-procedure site and an optional audio/video recording 338 of the patient's message to the physician and the patient-provided answers to a long term 339 (for example over two months) or a short-term 340 (for example less than two months) post-procedure follow-up. The physician can provide an online consultation by selecting pre-defined answers to a post-procedure assessment 343 indicating the state of the patient's current post-procedure condition, indicate the recommended physical activity level 342 that accounts for a given patient condition, and indicate whether the patient is required to provide another online follow up 344. The invention software can send an automated reminder notification to the patient on the date the physician requests an online follow up. The physician can select the appropriate staff member and the system can automatically notify via email the physician staff member of this request. Furthermore, the physician can write post-procedure specific comments to the patient 345 with recommendations for post-procedure care, indicate whether the patient is required to come for an in-office follow up visit 346 (for example the physician can select the appropriate staff member and the invention automatically notifies via email the staff member of this request), select the desired marketing or educational materials 348 for the patient to review, and record an optional audio/video message 349 with any desired audio and visual content. As an alternative to manually selecting answers to 343-349, the physician can choose to use a previously created template 341 for a relevant procedure.

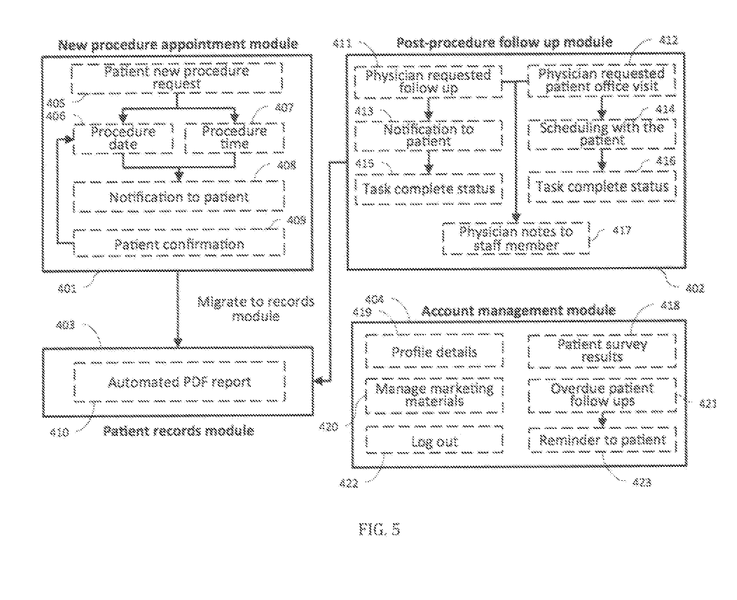

The invention can enable staff members that are invited by their physicians to use a secure process accessed through any web browser on a computer, mobile device or any other computing device to assist the physician with operational tasks that improve process efficiency. The staff account software 202, or software component #2, can be of any suitable type and include any number of modules. In one embodiment, staff account software 202 includes the four software or interface modules illustrated in FIGS. 2 and 5.

In one embodiment, the new procedure appointment module 208 can be in the form of some or all of new procedure appointment module 401 and can enable the staff member to log in to the staff account, using secure protocols, to review the patient new procedure appointment request 405 submitted by their physician (for example stored in the database on the storage of the cloud server 103). The staff member can review the physician's consultation and sets up a procedure date 406 and time 407 within the range of dates requested by the patient. The patient can receive an automated email notification 408 and confirm or cancel the proposed procedure date or requests alternative dates 409. Upon completion, task can be transferred to the Patients Records Module 403.

In one embodiment, the post-procedure follow-up module 209 can be in the form of some or all of post-procedure follow-up module 402 and can enable the staff member to log in to the staff account, using secure protocols, to review the physician's notes 417, and the patient follow-up appointment requests submitted by their physician (for example stored in the database on the storage of the cloud server 103). The staff member can set automated reminder notifications to patient 413 regarding the next online follow-up appointment on the date requested by the physician 411, and call the patient to set in-office follow-up appointment 414 as requested by their physician 412. Upon completion, task can be transferred to the patients records module 403.

In one embodiment, the patient records module 211 can be in the form of some or all of patient records module 403 and can enable the staff member to automate the generation process of PDF or other reports that incorporate complete records (for example patient answers, photos, physician consultation and notes) of any patient online pre-procedure and follow-up consultation.

In one embodiment, the account management module 210 can be in the form of some or all of account management module 404 and can enable the staff member to manage their profile details 419 (for example log in information and password), review the patient in-office visit experience survey results 418, create and manage a database of marketing materials 420, enabling the physician to market to their patients as part of the online consultations, receive and review daily automated notifications about patients that are overdue for a physician-requested online follow-up 421, send reminders to patients 423, securely log out 422 of the account.

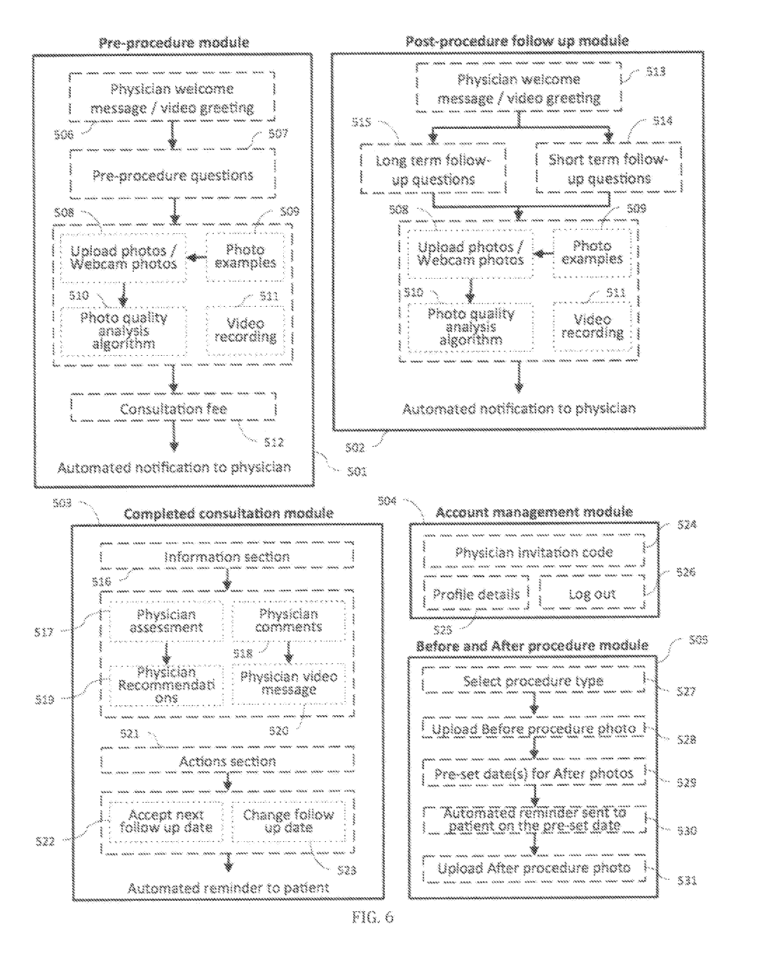

The invention can enable cosmetic and plastic surgery patients or other patients to use secure software accessed through any web browser on a computer, mobile device or other computing device to receive online asynchronous pre-procedure and post-procedure consultations from physicians. The patient account software 203, or software component #3, can be of any suitable type and include any number of modules. In one embodiment, patient account software 203 includes the four software or interface modules illustrated in FIGS. 2 and 6.

In one embodiment, the pre-procedure module 212 can be in the form of some or all of pre-procedure module 501 and can enable the patient to open an account using a unique patient invitation code linking the patient to their inviting physician or choose from any in-network physician. The patient can submit online a pre-procedure consultation request by reading the physician's welcome message and watch an optional physician welcome audio/video greeting 506 with instructions on how to use the service. A first time user can be walked through a step-by-step tutorial. The patient can then answer pre-procedure questions 507 regarding the desired procedure, timing, and general comments, and upload photo(s) of the pre-procedure site 508 following the provided examples 509 outlining best practices for each procedure type using such parameters as orientation, lighting conditions, part of the body to be photographed. The patient can upload one or more existing photos taken with any digital camera or mobile device using an upload function. The system can verify the image quality through a proprietary algorithm 510 that uses parameters such as exposure, focus and sharpness. The patient can be notified if an image does not meet the minimum quality requirements, and can be prompted to upload a new photo or continue with the initial photo. The patient can also take one or more photos using any web-cam connected or imbedded into a computer or other computing device, which can be instantiated by the patient using the invention software. The patient can record an optional audio/video message 511 for their physician describing their current condition, for example using a web cam, and upload the video. The patient can pay the physician-specified pre-procedure consultation fee 512. The system can send an automated notification to the physician once the patient submits the new procure consultation request.

In one embodiment, the post-procedure follow-up module 213 can be in the form of some or all of post-procedure follow-up module 502 and can enable the patient to submit online follow-up consultations by reading the physician customizable instructions on how to use the service and watch an optional physician welcome audio/video message 513, specifying whether this is a follow-up to an older procedure (for example over two months) 515 or a more recent procedure 514 and answer post-procedure follow up questions (for example the performed procedure, the date when the procedure was performed, date(s) when were the sutures were removed, discomfort level after the procedure, redness, swelling, bruising, temperature, activity level compared to normal, any comments for the doctor or any combination of the foregoing), upload image(s) or photo(s) of the post-procedure site 508 following the provided examples 509 outlining best practices for each procedure type using such parameters as orientation, lighting conditions, part of the body to be photographed. The patients can upload one or more existing photos taken with any digital camera or smart phone using an upload function. The system can verify the image quality through a proprietary algorithm 510 that can use parameters such as exposure, focus and sharpness. The patient can be notified if the image does not meet the minimum quality requirements, and can be prompted to upload a new photo or continue with the initial photo. The patient can also take one or more photos using any web-cam connected or imbedded into a computer or other computing device, which can be instantiated by the patient using the invention software. The patient can record an optional audio/video message 511 for their physician describing their current condition, for example using a web cam, and can upload the video to the media server 103. The patient can receive an automated notification when the physician provides the online consultation and logs in to their account to review the physician's assessment.

In one embodiment, the completed consultations module 215 can be in the form of some or all of completed consultations module 503 and can include information section 516, which can enable the patient to view the physician's assessment 517 (for example the healing process as expected versus the need to see the patient in person), the physician's comments 518, the physician's recommendations 519, the physician's optional audio/video message 520 with information regarding the patient's consultation request or any combination of the foregoing. In the actions section 521, the patient can review and accept the physician requested next online follow-up date 522, or change the physician requested online follow-up date 523. The system can send an automated reminder to the patient on the specified date.

In one embodiment, the account management module 214 can be in the form of some or all of account management module 504 and can enable the patient to use the physician invitation code 524 to link their account to a specific physician account, edit profile details 525 such as name and password, and securely log out of the account 526.

In one embodiment, the patient account software 203 can include before and after procedure module 505 and can enable the patient to select the procedure date and its description 527, upload one or more “before” procedure photos of their procedure site 528, view the system scheduled dates for “after” procedure photos to be uploaded 529, receive system-generated reminders for when to upload the recommended “after” procedure photos 530, and upload one or more “after” procedure photos 531.

It is appreciated that all of the software and components disclosed herein are not limited to the specific components and features itemized herein, but instead can include less than all of the specific components and features itemized herein, other components and features not disclosed herein and any combination of the foregoing.

It is appreciated that the invention can be modified to provide a similar interaction between patients and other fields of surgery or medicine in general.

In operation and use, the invention permits medical personnel, for example cosmetic dermatologists and plastic surgeons, to provide remote consultations to their existing follow up patients as well as new pre-procedure patients.

In one embodiment, a method for a patient having a computing device to communicate with clinical medical personnel regarding a surgical procedure is provided that can include opening an internet-accessible application, accessing a page of the application having a plurality of input fields, inputting information pertaining to the surgical procedure into the plurality of input fields, and receiving a communication on the computing device from the clinical medical personnel in response to the inputted information.

The communication can be in a standard format predetermined by the clinical medical personnel. The communication can include a cost estimate for the surgery procedure. The communication can include information pertaining to the patent's post-procedure condition. The inputting information step can include inputting information selected from the group consisting of a pre-cosmetic surgery procedure assessment and a pre-plastic surgery procedure assessment. The information can include an image of a pre-procedure site. The image can be a photograph, a video or both. The image can be taken by a camera, including a camera in a mobile electronic device and a webcam powered by a computer. The method can further include the step of viewing guidelines on the application for taking the image. The information can include an image of any portion of the patient, including an image a pre-procedure site and an image of a post-procedure site. The inputting information step can include inputting answers to post-procedure questions provided on the page. The computing device can be a mobile electronic device.

In one embodiment, a method for a patient having a computing device to communicate with clinical medical personnel regarding a plastic or cosmetic surgery procedure is provided that can include opening an internet-accessible application, accessing a page of the application having a plurality of input fields, inputting information pertaining to the plastic or cosmetic surgery procedure into the plurality of input fields, and receiving a communication on the computing device from the clinical medical personnel in response to the inputted information.

The information can include an image of a pre-procedure site, an image of a post-procedure site or both.

In one embodiment, one or more non-transitory computer readable storage media encoded with instructions executable by one or more processing units of a computing system controlling communications between a computing device of clinical medical personnel and a computing device of a patient is provided in which the instructions can include instructions for enabling the patient to open an internet-accessible application, access a page of the application having a plurality of input fields, input information pertaining to the surgical procedure into the plurality of input fields, and receive a communication on the computing device from the clinical medical personnel in response to the inputted information.

The computing device of the clinical medical personnel can include a mobile electronic device, a computer or both. The computing device of the patient can include a mobile electronic device, a computer or both. The instructions can further include instructions for notifying the patient's computing device when a physician has provided a remote consultation to the patient's computing device. The instructions can include instructions for enabling the patient to log into a webpage by means of an application on a mobile electronic device to view consultation results. The instructions can include instructions for automatically integrating the consultation results with electronic medical records of the clinical medical personnel. The inputted information can include an image and the instructions can include instructions for checking the quality of the image and notifying the patient if the image is not of a predetermined quality. The instructions can include instructions for requesting the patient to accept the image or input a replacement image.

In one embodiment, one or more non-transitory computer readable storage media encoded with instructions executable by one or more processing units of a computing system in compliance with the Health Insurance Portability and Accountability Act for use by a patient and medical personnel is provided in which instructions include instructions for receiving and transmitting an inquiry regarding a medical procedure of a portion of a body of a patient from the patient's Internet-connected computing device to a medical personnel's Internet-connected computing, receiving and transmitting an image of the portion of the patient's body from the patient's Internet-connected computing device to a medical personnel's Internet-connected computing and receiving and transmitting a response from the medical personnel's Internet-connected computing to the patient's Internet-connected computing device.

The patient's Internet-connected computing device can include a smartphone, a tablet, a laptop computer, a desktop computer or any combination of the foregoing. The medical personnel's Internet-connected computing device can include a smartphone, a tablet, a laptop computer, a desktop computer or any combination of the foregoing. The procedure can be an aesthetic surgical procedure, a plastic surgery procedure, a cosmetic procedure, a dermatological procedure or any other procedure. The inquiry can include completing a questionnaire relating to the medical procedure. The inquiry can be a pre-procedure inquiry or a post-procedure inquiry. The response can include information such as the estimated cost of the procedure, available times for the procedure, pre-procedure instructions or a physician's comments regarding the medical procedure. The response can include information such as indicating the state of the patients current post-procedure condition, indicating whether the patient is required to come for an in-office follow up visit, indicating whether the patient is required to provide another online follow up, indicating recommended physical activity level for the patient, writing any comments to the patient, cited marketing or educational materials for the patient relevant to the medical procedure, selecting post-procedure specific skin care or wound healing products, or providing a video message. The instructions can further include receiving and transmitting a video of the patient from the patient's Internet-connected computing device to a medical personnel's Internet-connected computing device. The instructions can further include capturing and transmitting a “before” and “after” procedure image from the patient's Internet-connected computing device to a medical personnel's Internet-connected computing device at pre-defined intervals. The instructions can further include providing a login screen requiring user-provided login information.

The method, apparatus and system of the invention is advantageous over existing medical consulting methods, devices and systems as it permits physicians and other medical personnel to offer existing and prospective patients the ability to receive remote consultations without physically visiting a medical office and thus build and grow their community of patients. The invention enables great convenience and time savings to patients and improved efficiency to physicians. The invention enables secure, HIPAA-compliant remote post-cosmetic or plastic surgery procedure follow up between a patient and their physician using a web browser on any computer or a mobile device. The invention enables a remote pre-surgery procedure assessment, for example pre-cosmetic or plastic surgery procedure assessment, to be performed online between prospective patients and surgeons, for example cosmetic dermatologists or plastic surgeons. The invention improves operational efficiency of physicians and provides great convenience to patients, for example plastic and cosmetic surgery patients.

I claim:

1. A method for a patient having a computing device to communicate with clinical medical personnel regarding a surgical procedure, comprising opening an internet-accessible application, accessing a page of the application having a plurality of input fields, inputting information pertaining to the surgical procedure into the plurality of input fields, and receiving a communication on the computing device from the clinical medical personnel in response to the inputted information.

2. The method of claim 1, wherein the communication is in a standard format predetermined by the clinical medical personnel.

3. The method of claim 1, wherein the communication includes a cost estimate for the surgery procedure.

4. The method of claim 1, wherein the communication includes information pertaining to the patent's post-procedure condition.

5. The method of claim 1, wherein the inputting information step includes inputting information selected from the group consisting of a pre-cosmetic surgery procedure assessment and a pre-plastic surgery procedure assessment.

6. The method of claim 1, wherein the information includes an image of a pre-procedure site.

7. The method of claim 6, wherein the image is selected from the group consisting of a photograph and a video.

8. The method of claim 6, wherein the image is taken by a camera selected from the group consisting of a camera in a mobile electronic device and a webcam powered by a computer.

9. The method of claim 6, further comprising the step of viewing guidelines on the application for taking the image.

10. The method of claim 1, wherein the information includes an image selected from the group consisting of a pre-procedure site and a post-procedure site.

11. The method of claim 1, wherein the inputting information step includes inputting answers to post-procedure questions provided on the page.

12. The method of claim 1, wherein the computing device is a mobile electronic device.

13. A method for a patient having a computing device to communicate with clinical medical personnel regarding a plastic or cosmetic surgery procedure, comprising opening an internet-accessible application, accessing a page of the application having a plurality of input fields, inputting information pertaining to the plastic or cosmetic surgery procedure into the plurality of input fields, and receiving a communication on the computing device from the clinical medical personnel in response to the inputted information.

14. The method of claim 1, wherein the information includes an image of a pre-procedure site.

15. The method of claim 1, wherein the information includes an image of a post-procedure site.

16. One or more non-transitory computer readable storage media encoded with instructions executable by one or more processing units of a computing system controlling communications between a computing device of clinical medical personnel and a computing device of a patient, the instructions comprising instructions for enabling the patient to open an internet-accessible application, access a page of the application having a plurality of input fields, input information pertaining to the surgical procedure into the plurality of input fields, and receive a communication on the computing device from the clinical medical personnel in response to the inputted information.

17. The non-transitory computer readable storage media of claim 16, wherein the computing device of the clinical medical personnel is selected from the group consisting of a mobile electronic device and a computer.

18. The non-transitory computer readable storage media of claim 16, wherein the computing device of the patient is selected from the group consisting of a mobile electronic device and a computer.

19. The non-transitory computer readable storage media of claim 16, wherein the instructions further include instructions for notifying the patient's computing device when a physician has provided a remote consultation to the patient's computing device.

20. The non-transitory computer readable storage media of claim 19, wherein the instructions include instructions for enabling the patient to log into a webpage by means of an application on a mobile electronic device to view consultation results.

21. The non-transitory computer readable storage media of claim 19, wherein the instructions include instructions for automatically integrating the consultation results with electronic medical records of the clinical medical personnel.

22. The non-transitory computer readable storage media of claim 19, wherein the inputted information includes an image and the instructions include instructions for checking the quality of the image and notifying the patient if the image is not of a predetermined quality.

23. The non-transitory computer readable storage media of claim 22, wherein the instructions include instructions for requesting the patient to accept the image or input a replacement image.
